(19) United States
(12) Patent Application Publication
(10) Pub. No.: US 2010/0051209 A1
(43) Pub. Date: Mar. 4, 2010

(54) Roman shade assembly

(76) Inventors: Wen Ying Liang, Fuxing Shiang (TW); Sheng Ying Hsu, Fuxing Shiang (TW); Wu Chung Nien, Fuxing Shiang (TW); Chien Chih Huang, Fuxing Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,193

(22) Filed: Sep. 12, 2008

(30) Foreign Application Priority Data
Aug. 28, 2008 (TW) 097215488

(51) Int. Cl. E06B 9/26

(52) U.S. Cl. 160/84.04

(57) ABSTRACT

A Roman shade assembly includes a frame and a shade which is removably connected to the frame. The shard is composed of an inner portion and an outer portion. A first connection member is connected to the frame and the inner portion has a second connection member which is removably connected to the first connection member. The inner portion and the outer portion are connected to each other by a third connection member and a fourth connection member. The shade can be easily removed from or connected to the frame. The inner portion and the outer portion are easily separated by separating the third and fourth connection members.

### FIELD OF THE INVENTION

The present invention relates to a Roman shade assembly, and more particularly, to a Roman shaft assembly including an inner portion and an outer portion which can be separated from the inner portion.

### BACKGROUND OF THE INVENTION

One of the conventional Roman shades generally includes a frame which is cooperated with sliding fastening members to secure the fabric of the Roman shade. However, the Roman shade is not convenient for the user to clean because the user has to remove the sliding fastening members from the frame. This takes a lot of time and all the sliding fastening members are re-connected to the frame after the fabric is cleaned. The other one of the conventional Roman shades uses bolts to fix the fabric of the Roman shade. The bolts penetrate the fabric of the Roman shade and may cause damage to the fabric. Besides, the fabric of the Roman shade is deformed at the portion where the bolts extend.

The present invention intends to provide a Roman shade assembly which includes a frame and a shade, the shade is composed of an inner portion and an outer portion which is connected to the inner portion by using hook and loop connection members. The shade is connected to the frame by using hook and loop connection members.

### SUMMARY OF THE INVENTION

The present invention relates to a Roman shade assembly which comprises a frame with a first connection member connected thereto and a shade which is connected to the frame. The shade includes an inner portion and an outer portion, wherein the inner portion includes a first side and a second side. The first side of the inner portion has a second connection member which is removably connected to the first connection member. A third connection member is connected to the second side of the inner portion. The outer portion has a first side and a second side, a fourth connection member is connected to the first side of the outer portion and removably connected to the third connection member.

The primary object of the present invention is to provide a Roman shade assembly wherein the shade can be removed from the frame by separating two loop-and-hook connection members.

Another object of the present invention is to provide a Roman shade assembly wherein the shade is composed of an inner portion and an outer portion which is connected to the inner portion by two loop-and-hook connection members.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the Roman shade assembly of the present invention;

FIG. 2 is an exploded view to show the Roman shade assembly of the present invention;

FIG. 3 is a cross sectional view to show the connection of the frame and the shade of the Roman shade assembly of the present invention;

FIG. 4 is shows a rod extending through a passage of the shade of the Roman shade assembly of the present invention;

FIG. 5 shows a part of the shade of the Roman shade assembly of the present invention;

FIG. 6 is an exploded view to show a second embodiment of the Roman shade assembly of the present invention;

FIG. 7 is an exploded view to show a third embodiment of the Roman shade assembly of the present invention;

FIG. 8 shows that the Roman shade assembly of the present invention is cooperated with an operation cord, and

FIG. 9 shows that the Roman shade assembly of the present invention is cooperated with a lift cord.

### DETAILED DESCRIPTION OF THE PREFERRED EMBODIMENT

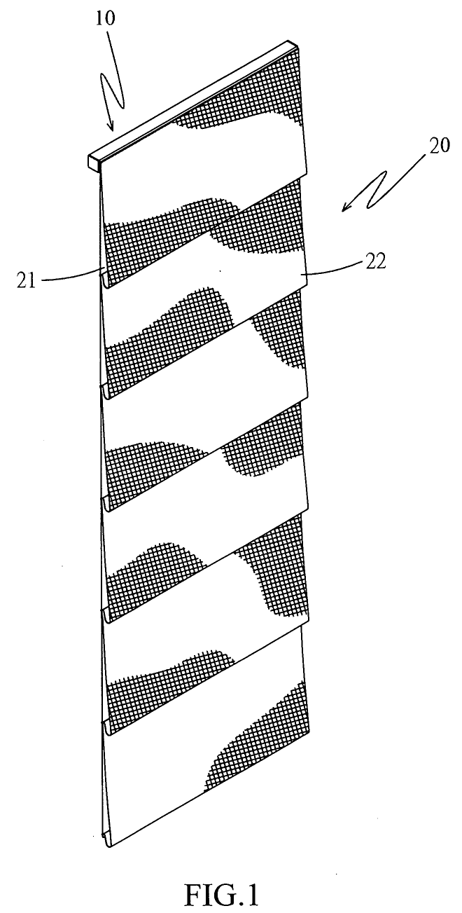

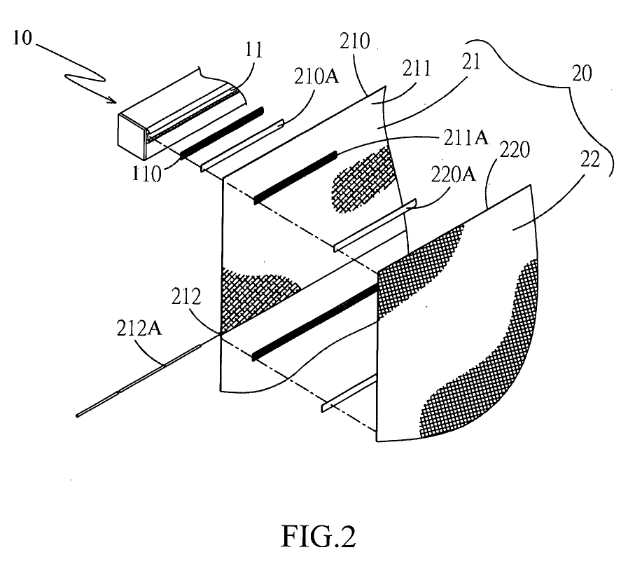

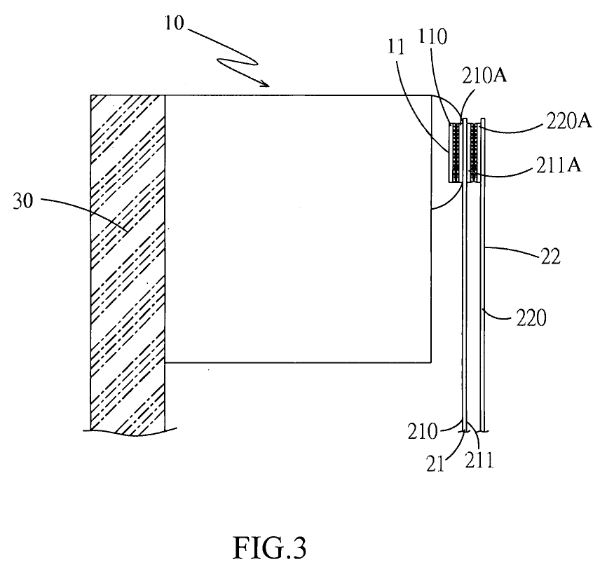

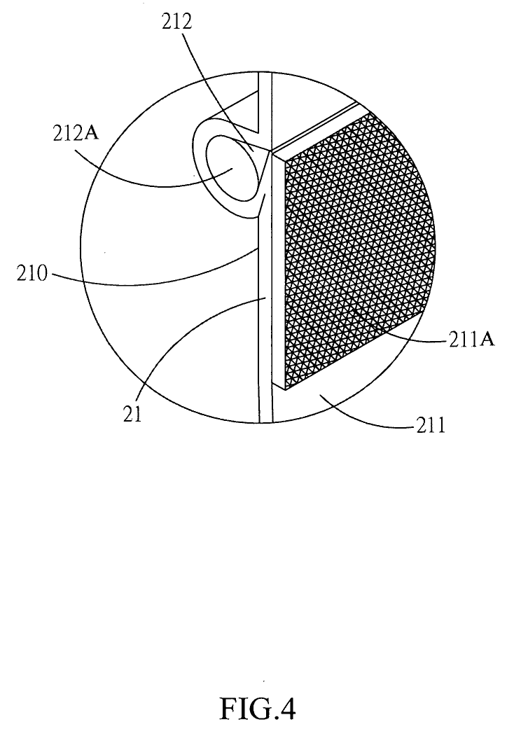

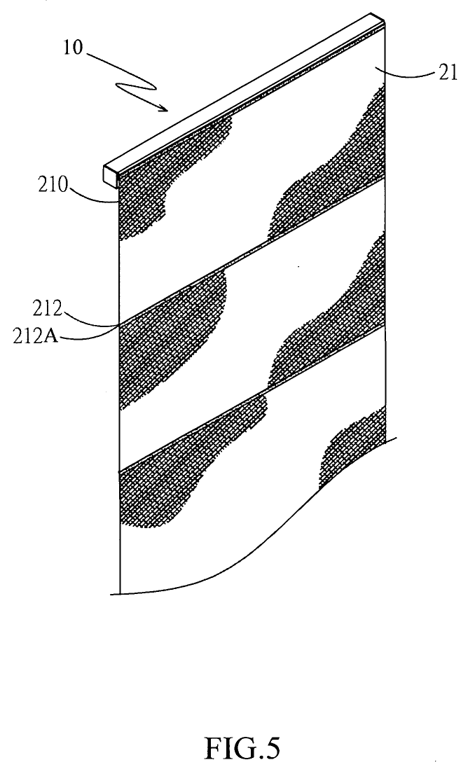

Referring to FIGS. 1 to 5, the Roman shade assembly of the present invention comprises a frame 10 and a shade 20, wherein the frame 10 is fixed to the wall 30 and includes a U-shaped slot 11 defined in a front surface thereof. A first connection member 110 is secured in the U-shaped slot 11.

The shade 20 includes an inner portion 21 and an outer portion 22. The inner portion 21 includes a first side 210 and a second side 211, the first side of the inner portion 21 has a second connection member 210A which is removably connected to the first connection member 110. A third connection member 211A is connected to the second side 211 of the inner portion 21.

The outer portion 22 includes a first side and a second side, wherein a fourth connection member 220A is connected to the first side of the outer portion 22 and removably connected to the third connection member 211A.

The first, second, third and fourth connection members 110, 210A, 211A and 220A each have a hook-and-loop surface so as to be connected to each other by engaging the hooks to the loops. Also, the first and second connection members 110, 211A can be made to have only hooks on their surfaces, and the second and fourth connection members 210A, 220A can be made to have only loops on their surfaces.

The inner portion 21 includes multiple passages 212 defined transversely therethrough and a rod 212A extends through each of the passages 21 so that the shade 20 has proper strength.

The first, second, third and fourth connection members 110, 210A, 211A and 220A can be easily separated from each other or connected to each other, this allows the user to conveniently clean the shade 20.

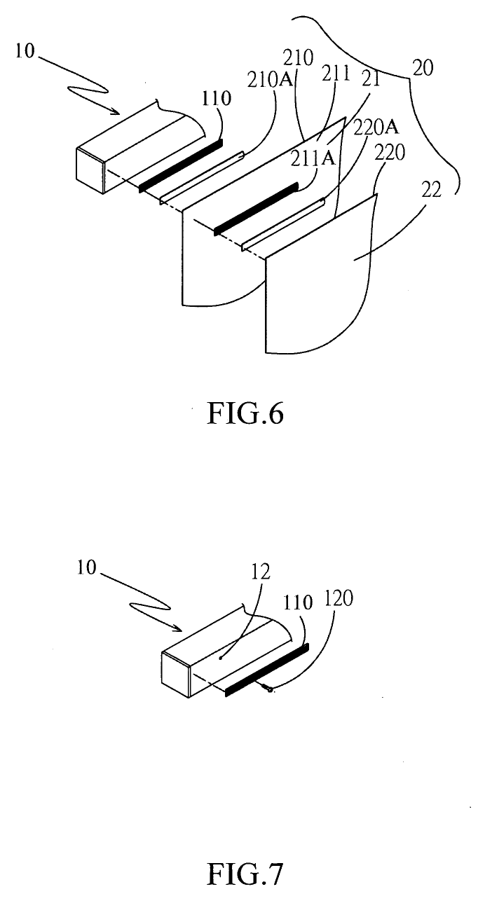

FIG. 6 shows that the frame 10 can be made not to have the elongate slot 11 and the first connection member 110 can be directly adhered to the frame 10.

FIG. 7 shows that the frame 10 can be made not to have the elongate slot 11 and the first connection member 110 can be directly fixed to the frame 10 by extending screws 120 through the first connection member 110 and fixed to the frame 10

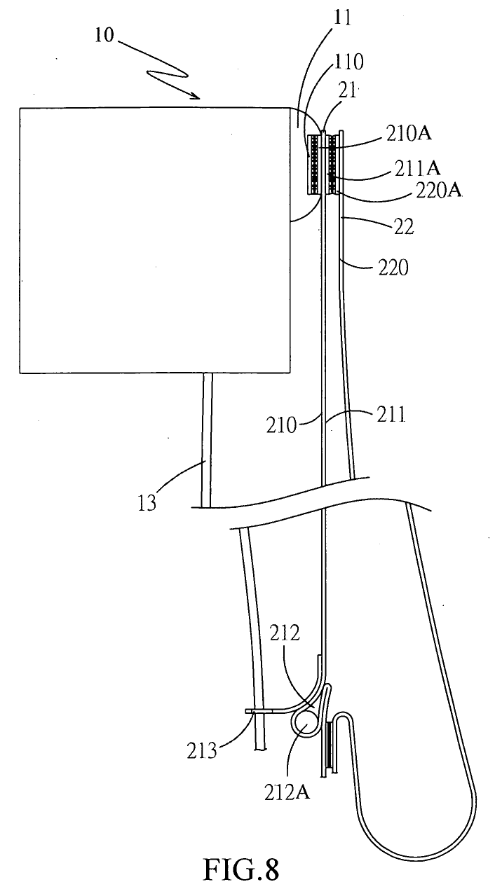

FIG. 8 shows that a ring part 213 is a curved part and has one end connected to the inner part 21, the other end of the ring part 213 includes a ring. Preferably, the ring part 213 is located beside the passage 212. An operation cord 13 has one end connected to the frame 10 and the other end extends through the ring of the ring part 213.

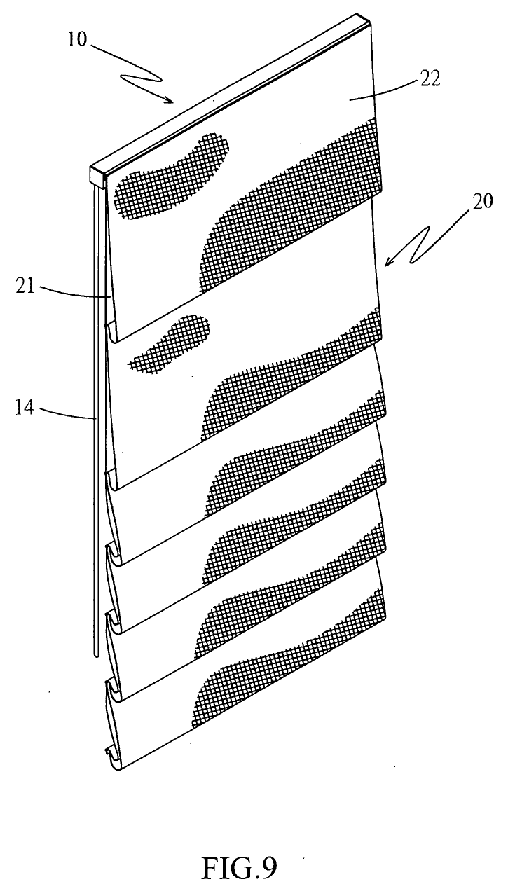

FIG. 9 shows that a lift cord 14 extends from the frame 10 so as to lift the shade 20.

The shade 20 is composed by the inner portion 21 and the outer portion 22 which is connected to the inner portion 21 by the third and fourth connection members 211A, 220A having hook-and-loop surfaces, so that the inner and outer portions 21, 22 are easily combined together and separated from each other. Similarly, the inner portion 21 and the frame 10 are connected to each other by the first and second connection members 110, 210A having hook-and-loop surfaces, so that the inner portion 21 and the frame 10 are easily combined together and separated from each other. The inner portion 21 and/or the outer portion 22 can be replaced with different new ones of different colors by the users easily.

While we have shown and described the embodiment in accordance with the present invention, it should be clear to those skilled in the art that further embodiments may be made without departing from the scope of the present invention.

What is claimed is:

1. A Roman shade assembly comprising:
a frame and a first connection member connected to the frame;
a shade including an inner portion and an outer portion, the inner portion including a first side and a second side, the first side having a second connection member which is removably connected to the first connection member, a third connection member connected to the second side, the outer portion having a first side and a second side, a fourth connection member connected to the first side of the outer portion and removably connected to the third connection member.

2. The assembly as claimed in claim 1, wherein the first connection member is fixed to the frame by extending screws through the first connection member and fixed to the frame

3. The assembly as claimed in claim 1, wherein the frame includes a U-shaped slot and the first connection member is secured in the U-shaped slot.

4. The assembly as claimed in claim 1, wherein the inner portion includes a passage defined transversely therethrough and a rod extends through the passage.

5. The assembly as claimed in claim 4, wherein an operation cord extends from the frame and a ring part extends from the inner part, the ring part includes a ring through which the operation cord extends.

6. The assembly as claimed in claim 5, wherein the ring part extends from the inner part and is located beside the passage.

7. The assembly as claimed in claim 1, wherein a lift cord extends from the frame so as to lift the shade.

8. The assembly as claimed in claim 1, wherein the first, second, third and fourth connection members have a hook-and-loop surface.
